(19) United States
(12) Patent Application Publication
(10) Pub. No.: US 2008/0158599 A1
(43) Pub. Date: Jul. 3, 2008

(54) Print support system, print support program, and print support method

(75) Inventor: Shinji Miwa, Hokuto-shi (JP)

Correspondence Address: Edwards Angell Palmer & Dodge LLP, P. O. Box 55874, Boston, MA, 02205, US

(73) Assignee: Seiko Epson Corporation, Tokyo (JP)

(21) Appl. No.: 12/005,076

(22) Filed: Dec. 21, 2007

(30) Foreign Application Priority Data
Dec. 27, 2006 (JP) 2006-351207
Feb. 15, 2007 (JP) 2007-035014

(51) Int. Cl. G06F 15/00

(52) U.S. Cl. 358/1.15

(57) ABSTRACT

A print support system supports a printing operation of printing content represented by content data having a plurality of pages so that a final print appearance suitable for the content data is attained. The print support system includes a content data obtaining unit configured to obtain the content data, and a final print appearance estimation unit configured to estimate the final print appearance of the content data on the basis of content continuity of the content data obtained using the content data obtaining unit.

The entire disclosure of Japanese Patent Application No. 2006-351207, filed Dec. 27, 2006 and Japanese Patent Application No. 2007-035014, filed Feb. 15, 2007 are expressly incorporated by reference herein.

### BACKGROUND

1. Technical Field

The present invention relates to a print support system used to obtain an appropriate result of printing in accordance with content data, a print support program, and a print support method.

2. Related Art

In recent years, various brochures and documents have been publicized on the Internet as content data such as PDF (Portable Document Format) data. To cope with this, print job definition data (such as a JDF (Job Definition Format)) including information about a final print appearance is generated in a content data generation/distribution section and is transmitted to a user along with the content data so that the user can control a printing operation for printing the content data so that the content data has a final print appearance like a brochure, for example.

Furthermore, Japanese Unexamined Patent Application Publication No. 2003-173252 discloses, as a technique used when content data including setting information used for printing, such as the print job definition data, added thereto is printed, a technique of notifying the user of a fact that the setting information does not match a printing condition of the printing apparatus. Thus, an appropriate result of printing is obtained by transmitting a notification to the user so that setting is changed.

The final print appearance can be reproduced by the user using the print job definition data as described above. However, since the print job definition data is manually input using the content data generation/distribution section, inputting errors may be made. Since brochures, for example, have complicated structures unlike general documents, that is, the brochures may be folded in three or the brochures may be constituted as gatefolds in most cases, when wrong print job definition data is input, it is difficult for the user to reproduce such printed material on the basis of page numbers, for example, of the content data arranged in a plane.

On the other hand, in the technique disclosed in Japanese Unexamined Patent Application Publication No. 2003-173252, although a mismatch between the setting information added to the content data and the printing condition for the printing apparatus is detected, wrong setting information is not detected.

### SUMMARY

An advantage of some aspects of the invention is to provide a print support system capable of appropriately reproducing a final print appearance, a print support program, and a print support method.

According to an aspect of the invention, there is provided a print support system which supports a printing operation of printing content represented by content data having a plurality of pages so that a final print appearance suitable for the content data is attained. The print support system includes a content data obtaining unit configured to obtain the content data, and a final print appearance estimation unit configured to estimate the final print appearance of the content data on the basis of content continuity of the content data obtained using the content data obtaining unit.

With this configuration, a final print appearance of the content represented by the content data is estimated from continuity of pages of the content on the basis of the content continuity.

The content data obtaining unit may have any configuration as long as the content data obtaining unit can obtain content data. For example, the content data obtaining unit may obtains content data from an input device, for example, may obtains or receives content data from an external device, for example, and may read content data from a storage device or a storage medium, for example. Accordingly, the content data obtaining unit has an obtaining function in which the content data is at least input, obtained, received, or read by the content data obtaining unit. The attribute information obtaining unit for example, has the same obtaining function.

Note that this system may be realized using a single apparatus, a single terminal, or a single device. Alternatively, this system may be realized as a network system employing a plurality of apparatuses, a plurality of terminals, or a plurality of devices, which are connected to one another. In the latter case, the components of the embodiment may be included in any of the plurality of apparatuses, a plurality of terminals, or a plurality of devices, as long as the components are connected to one another so as to communicate with one another.

### BRIEF DESCRIPTION OF THE DRAWINGS

The invention will be described with reference to the accompanying drawings, wherein like numbers reference like elements.

FIG. 1A is a diagram illustrating a configuration of a print support system according to an embodiment of the invention.

FIG. 1B is a diagram illustrating a configuration of a printing system according to the embodiment of the invention.

FIG. 2 is a block diagram illustrating functions of a content data analyzer and a final print appearance estimation unit.

FIG. 3 is a flowchart illustrating processing performed using the content data analyzer.

FIG. 4 is a flowchart illustrating content data normalizing processing.

FIG. 5 is a diagram illustrating a data configuration of a final print appearance estimation rule.

FIG. 6 is a diagram illustrating an example of information included in print job definition data.

FIG. 7 is a diagram illustrating a hardware configuration of a host terminal.

FIG. 8 is a flowchart illustrating entire processing performed in the print support system.

FIG. 9A is a diagram illustrating an example of content data.

FIG. 9B is a diagram illustrating normalized content data.

FIG. 10 is a diagram illustrating a final print appearance of the content data of FIG. 9A.

FIG. 11 is a diagram illustrating printed material corresponding to the content data of FIG. 9A.

FIG. 12 is a diagram illustrating an example of an output displayed in a screen of a display device.

FIG. 13 is a diagram illustrating an example of a final print appearance estimation rule.

FIG. 14 is a diagram illustrating an example of a final print appearance estimation rule.

FIG. 15 is a diagram illustrating an example of content data.

FIG. 16 is a diagram illustrating printed material corresponding to the content data of FIG. 15.

FIG. 17 is a diagram illustrating a final print appearance estimation rule defining a final print appearance of the printed material of FIG. 16.

FIG. 18 is a diagram illustrating the relationship between identifiers of pages and arrangement of pages.

FIG. 19 is a diagram illustrating an example of an output of a final print appearance.

FIG. 20 is a diagram illustrating an example of content data.

FIG. 21 is a diagram illustrating a printed matter corresponding to the content data of FIG. 20.

FIG. 22A is a diagram illustrating an example of content data.

FIG. 22B is a normalized content data.

FIG. 23 is a diagram illustrating a final print appearance estimation rule applied to the content data of FIG. 22A.

FIG. 24 is a diagram illustrating printed material corresponding to the content data of FIG. 22A.

FIG. 25 is a diagram illustrating another example of an output displayed in the screen of the display device.

### DESCRIPTION OF EXEMPLARY EMBODIMENTS

### Entire Configuration

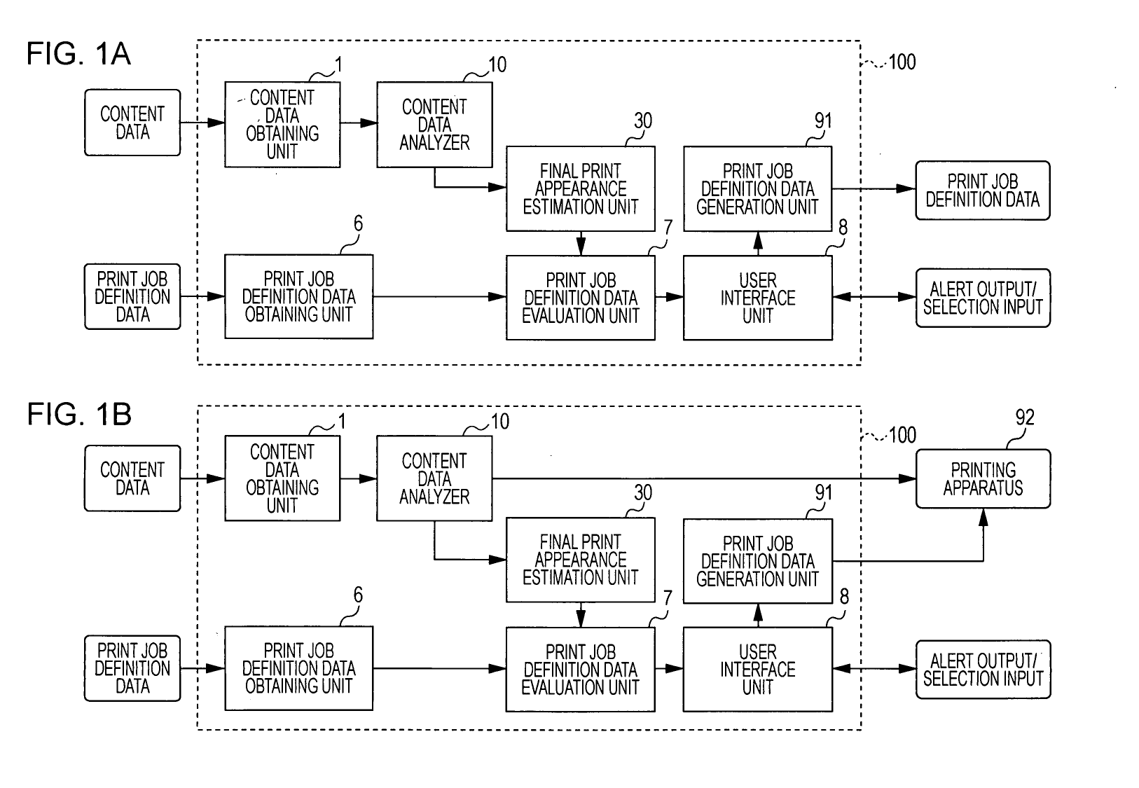

FIG. 1A shows a print support system according to an embodiment of the invention, and FIG. 1B shows a configuration of a printing system including the print support system.

The printing system shown in FIG. 1B includes the print support system having a host terminal 100 and a printing apparatus 92 connected to the host terminal 100.

The host terminal 100 includes a content data obtaining unit 1 which is used to obtain content data, a content data analyzer 10 which is used to analyze the content data obtained using the content data obtaining unit 1, and a final print appearance estimation unit 30 which is used to estimate a final print appearance on the basis of the content data. In this embodiment, the content data is described in a file by a page description language such as a PDF file. The content data may be obtained through a network such as the Internet or may be obtained from a storage apparatus, for example.

The host terminal 100 further includes a print job definition data obtaining unit 6 which is used to obtain print job definition data including information about a final print appearance of the content data. The content data and the print job definition data are associated with each other. The final print appearance is obtained in accordance with the association. A method for associating the content data and the print job definition data is not particularly limited. Examples of the method include a method for combining the print job definition data and the content data as a unit, a method for including a link to the content data in the print job definition data, and a method for including a link to the print job definition data in the content data. The print job definition data will be described in detail later.

The host terminal 100 includes a print job definition data evaluation unit 7 which is used to determine whether a final print appearance included as information in the print job definition data matches a final print appearance estimated using the final print appearance estimation unit 30, and output an alert through a user interface unit 8 when the host terminal 100 determines that the final print appearance included as information in the print job definition data does not match the final print appearance estimated using the final print appearance estimation unit 30. The user interface unit 8 includes a display device 107 and an input device 105 which will be described later for the host terminal 100.

The host terminal 100 further includes a print job definition data generation unit 91 which is used to generate a print job definition data including information about a final print appearance finally determined and output the print job definition data to a printing apparatus 92.

The printing apparatus 92 prints the content data supplied from the content data analyzer 10 so that the final print appearance finally determined is obtained on the basis of the print job definition data supplied from the print job definition data generation unit 91. The printing apparatus 92 has a function of interpreting the print job definition data and performing a printing operation.

### Configurations and Operations of Content Data Analyzer and Final Print Appearance Estimation Unit

Processing of analyzing content data and processing of estimating a final print appearance using the content data analyzer 10 and the final print appearance estimation unit 30, respectively, will be described.

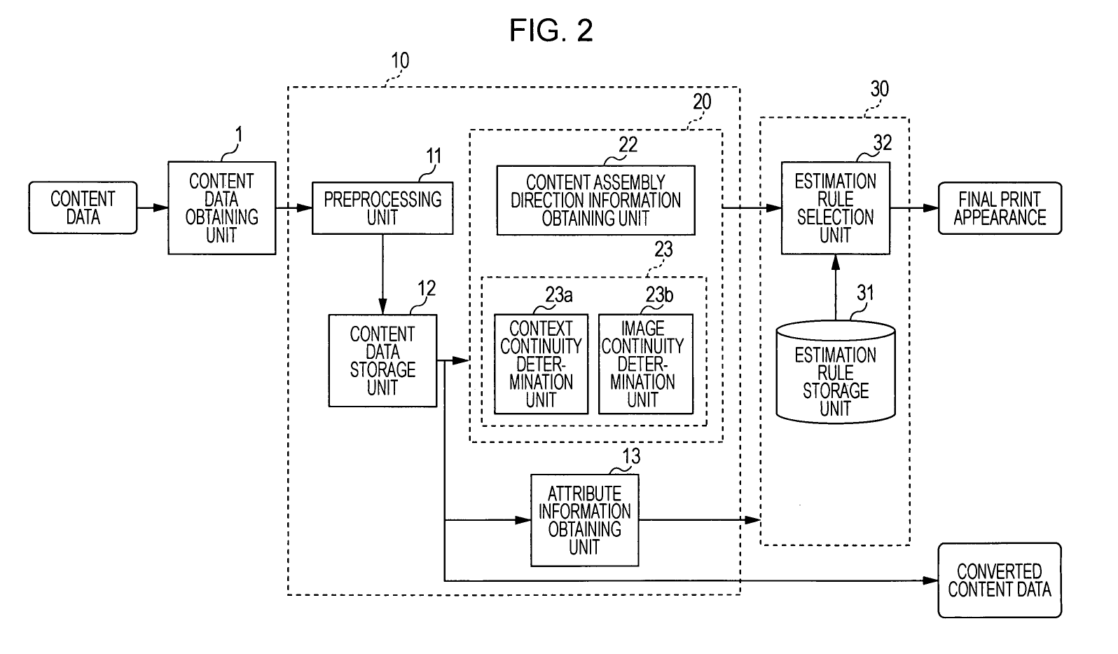

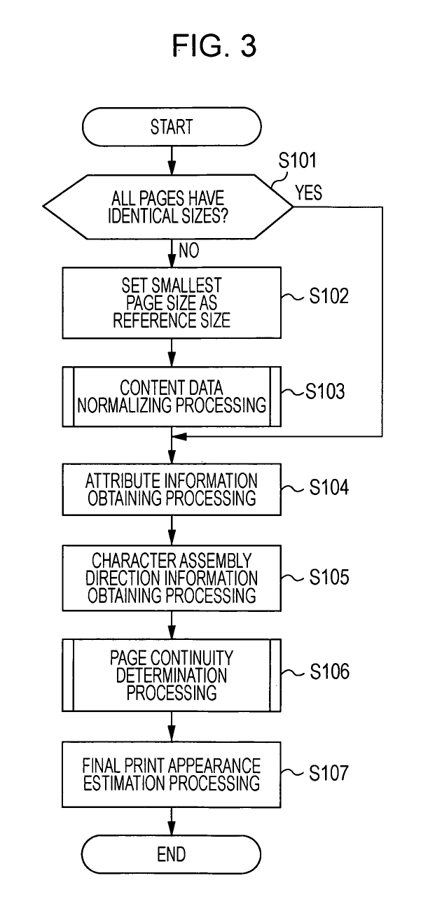

FIG. 2 is a block diagram illustrating functions of the content data analyzer 10 and the final print appearance estimation unit 30. FIG. 3 is a flowchart illustrating processing performed using the content data analyzer. As shown in FIG. 2, the content data analyzer 10 includes a preprocessing unit 11, a content data storage unit 12 which stores therein content data after being subjected to conversion processing using the preprocessing unit 11, an attribute information obtaining unit 13, and a content continuity analyzer 20.

The preprocessing unit 11 performs a preprocessing operation of converting content data obtained using the content data obtaining unit 1 so as to have a format suitable for analyzing continuity of content. In this embodiment, the preprocessing unit 11 performs processing from step S101 to S103 of FIG. 3 so that a plurality of pages of the content represented by the content data have identical sizes. The preprocessing operation will be described in detail hereinafter. In step S101, it is determined whether the plurality of pages of the content represented by the content data have identical sizes. Specifically, when the content data is supplied from the content data obtaining unit 1 to the preprocessing unit 11, the preprocessing unit 11 extracts pieces of information about the sizes (widths and heights) of the plurality of pages of the content represented by the content data and determines whether the sizes are identical. When the determination is negative in step S101, the process proceeds to step S102 where a reference size (a reference width and a reference height) is set. In the flowchart of FIG. 3, a smallest one of the sizes of the plurality of pages is determined as the reference size. Subsequently, in step S103, content data normalizing processing is performed so that all the pages of the content represented by the content data have the reference sizes. Note that when the determination is affirmative in step S101, the content data normalizing processing is not performed, the content data which remains unchanged is supplied to the content data storage unit 12, and the process proceeds to step S104.

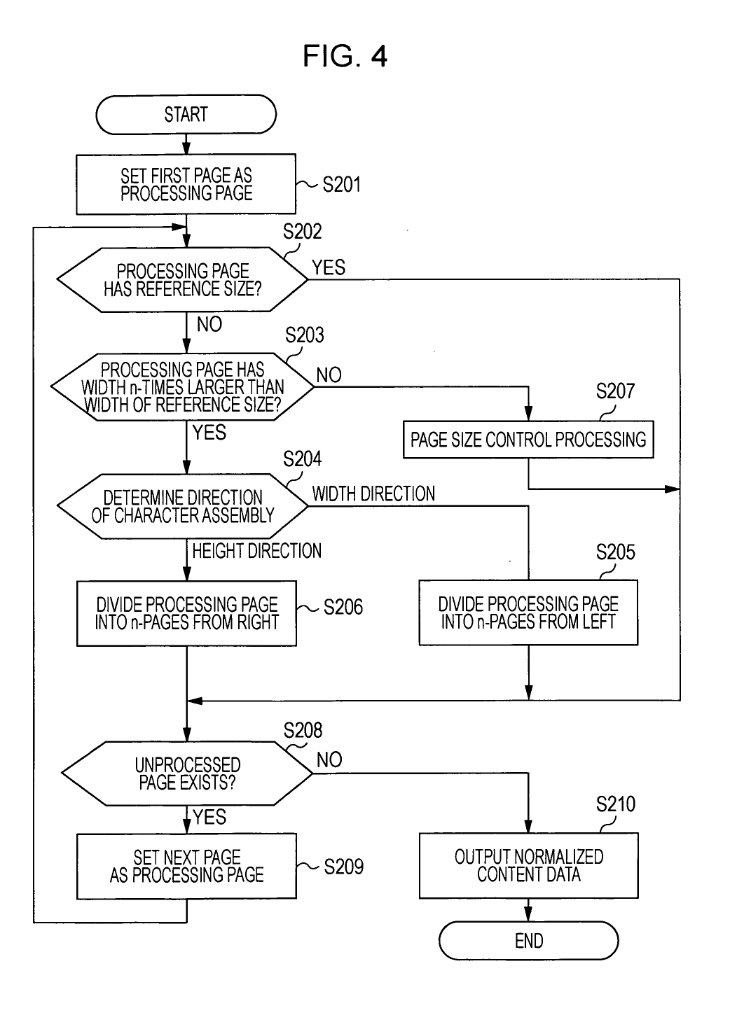

FIG. 4 is a flowchart illustrating the content data normalizing processing. In the content data normalizing processing, the first page is set as a page to be subjected to the content data normalizing processing (hereinafter referred to as a “processing page”) in step S201. In step S202, it is determined whether the processing page has a reference size. When the determination is affirmative in step S202, since the size of the printing page does not need to be changed, steps S203 to S207 are skipped and the process proceeds to step S208. When the determination is negative in step S202, the process proceeds to step S203.

In step S203, it is determined whether a width of the printing page is n-times (n is an integer) larger than the reference width and a height of the printing page is n-times larger than the reference height. When the determination is affirmative in step S203, since it may be assumed that contents of n-pages are assigned to the printing page in a width direction, the printing page is divided into n-pages in the width direction. In this case, since a method for assigning the contents of n-pages to the printing page is determined on the basis of a direction of a character assembly of the printing page, information about the direction of the character assembly of the printing page is obtained in step S204. When it is determined that the direction of the character assembly is the width direction (horizontal writing) (in step S204: width), since the left side is used in binding, that is, the n-pages are assigned to the printing page from the left to the right according to page number, the printing page is divided from the left. On the other hand, when it is determined that the direction of the character assembly is the height direction (vertical writing) (in step S204: height), since the right side is used in biding, the printing page is divided from the right. Thereafter, the process proceeds to step S208.

On the other hand, when the determination is negative in step S203, the process proceeds to step S207 where the size of the page is adjusted. For example, in a case where the width and the height of the processing page are within a width and a height which are predetermined m-times larger or smaller than the width and the height of the reference size (m is not an integer), the size of the processing page is enlarged or reduced in the height direction or the width direction so that the processing page has the reference size. Thereafter, the process proceeds to step S208.

Note that the processing performed in steps S203 to S207 is merely an example, and other methods for detecting the difference between the size of the processing page and the reference size and adjusting the size of the processing page are prescribed as content data normalization rules. Then, an appropriate content data normalization rule is selected from among the content data normalization rules in accordance with a state of the processing page, and the processing page is adjusted so as to have the reference size in accordance with the selected content data normalization rule. For example, as with the case where the width of the processing page is n-times larger than the width of the reference size as described in step S203, in a case where the height of the processing page is n-times larger than the height of the reference size, the processing page is divided in the height direction. In addition to such dividing processing and enlargement or reduction of the size of the processing page described above, trimming processing may be performed, and furthermore, a combination of any of the dividing processing, the enlargement/reduction processing, and the trimming processing may be performed as needed.

In step S208, it is determined whether an unprocessed page exist. When the determination is negative, the processed content data (normalized content data) is supplied to the content data storage unit 12 in step S210. On the other hand, when the determination is affirmative, the processing from step S202 to S208 is repeated until all pages are processed.

As described above, after the preprocessing unit 11 performs the preprocessing operation of analyzing the continuity of the content data and the content data normalizing processing, the content data which is converted and normalized is supplied to the content data storage unit 12. On the other hand, in a case where the content data normalizing processing is not performed, the content data obtained using the content data obtaining unit 1 which remains unchanged is supplied to the content data storage unit 12.

The attribute information obtaining unit 13 obtains attribute information of content data of interest from among pieces of content data stored in the content data storage unit 12. The attribute information is information about the content data and does not represent the continuity of the content but is necessary for estimating the final print appearance. In this embodiment, the attribute information obtaining unit 13 obtains information about the number of pages from the content data and supplies the information about the number of pages to the final print appearance estimation unit 30. The attribute information obtaining unit 13 performs the processing of obtaining the attribute information in step S104 of FIG. 3 after the preprocessing unit 11 performs the preprocessing operation.

The content continuity analyzer 20 includes a character assembly direction information obtaining unit 22 and a page continuity determination unit 23. The content continuity analyzer 20 analyzes continuity of content. The character assembly direction information obtaining unit 22 performs processing in step S105 of FIG. 3 after the attribute information obtaining unit 13 obtains the attribute information. The character assembly direction information obtaining unit 22 refers to the content data stored in the content data storage unit 12, obtains pieces of character assembly direction information for a plurality of pages, and supplies the pieces of character assembly direction information to the final print appearance estimation unit 30. Note that, the processing performed using the character assembly direction information obtaining unit 22 is the same as the operation performed in step S204 in the content data normalizing processing, except that the processing is performed on each of the plurality of pages of the content data using the character assembly direction information obtaining unit 22.

The page continuity determination unit 23 performs page continuity determination processing in step S106 of FIG. 3 after the character assembly direction information obtaining unit 22 performs processing. In the page continuity determination processing, pairs of pages which have content continuity are determined. Then, identifiers (page numbers, for example) of the pairs of pages which have continuity of content are supplied to the final print appearance estimation unit 30. The page continuity determination unit 23 includes a context continuity determination unit 23a and an image continuity determination unit 23b.

The context continuity determination unit 23a determines whether character strings described in the plurality of pages of the content data have continuity in context, and among the plurality of pages, pairs of pages which have continuity in context are determined to be pairs of pages which have content continuity. Thereafter, the identifiers (page numbers, for example) for the pairs of pages which have content continuity are output. Specifically, the character strings are extracted from the plurality of pages of the content data by extracting character codes from character plotting instructions included in the corresponding pages. One of the extracted character strings included in a corresponding one of the plurality of pages (hereinafter referred to as a “first comparison page”) is combined with another one of the extracted character strings included in a corresponding one of the plurality of pages (hereinafter referred to as a “second comparison page”) so as to be subjected to syntax analysis. When the combination of the character strings is syntactically correct, it is determined that the first comparison page and the second comparison page have continuity. Note that the continuity in context is examined for all pairs of the pages which may be a pair of successive pages or may not be a pair of successive pages. In this way, all pairs of pages which are represented by the content data and which have continuity are extracted. Note that when the continuity in context is examined, one of a plurality of rows of the first comparison page and a corresponding one of a plurality of rows of the second comparison page may be examined (for example, the fifth row), or the end of the first comparison page and the beginning of the second comparison page may be examined.

The image continuity determination unit 23b determines that an image described in the plurality of pages of the content data corresponds to an image constituted by continuous regions. Pairs of pages, among the plurality of pages, which are determined as the continuous regions including the image are determined as pairs of pages which have content continuity. Then, identifiers (page numbers, for example) of the pairs of the pages which have content continuity are output. Specifically, for example, gradations of areas in the vicinity of edges of the plurality of pages are detected. When it is determined that the gradation and position of one of the edges (hereinafter referred to as a “first edge”) coincide with those of another one of the edges (hereinafter referred to as a “second edge”), a page including the first edge and a page including the second edge are determined to have continuity. That is, for the plurality of pages, continuity of areas in the vicinity of the edges arranged in a width direction is examined, histograms of gradations in a height direction in the areas are generated, the histograms of the plurality of pages are compared with one another, and pairs of pages which have identical histograms patterns are determined as pairs of pages which have continuity. Similarly, continuity of areas in the vicinity of the edges arranged in the height direction is examined, histograms of gradations in the width direction in the areas are generated and the histograms of the plurality of pages are compared with one another. Note that the histograms of the gradations of the areas in the vicinity of the edges arranged in the width direction may be compared with the histograms of the gradations of the areas in the vicinity of the edges arranged in the height direction.

The final print appearance estimation unit 30 estimates the final print appearance of the content data on the basis of a result of the analysis supplied from the content continuity analyzer 20 and the attribute information of the content data supplied from the attribute information obtaining unit 13. Such final print appearance estimation processing is performed in step S107 of FIG. 3 after the page continuity determination processing is performed. The final print appearance estimation unit 30 includes an estimation rule storage unit 31 and an estimation rule selection unit 32.

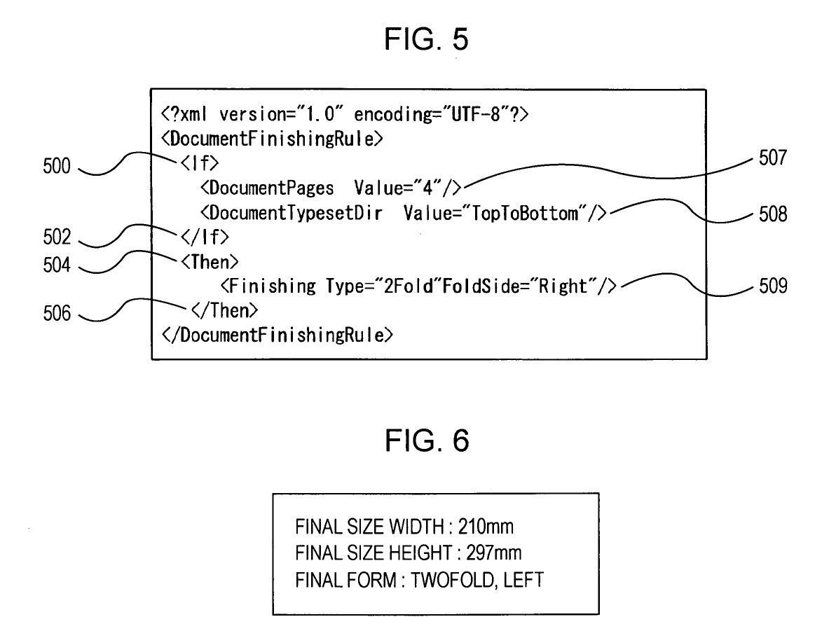

FIG. 5 is a diagram illustrating a data configuration of the final print appearance estimation rule. The final print appearance estimation rule is data in which a rule for estimating a final print appearance based on the information about the continuity of the content data and the attribute information of the content data is described. As shown in FIG. 5, in the final print appearance estimation rule, tag sets are inserted between a predetermined start tag (for example, <DocumentFinishingRule>) and a predetermined end tag (for example, </DocumentFinishingRule>) so as to be a nested structure. By this, a final print appearance is prescribed on the basis of the information about the continuity of the content data and the attribute information of the content data. For example, the final print appearance rule may be described in a markup language such as XML.

The result of analysis obtained using the content continuity analyzer 20 and the attribute information are prescribed as conditions in a tag set between a start tag 500 and an end tag 502. A final print appearance employed when the conditions prescribed in the tag set between the start tag 500 and the end tag 502 are satisfied is prescribed in a tag set between a start tag 504 and an end tag 506. In an example in FIG. 5, the number of pages of the content data is four (described in a tag 507), and when a direction of a character assembly is from the top to the bottom, that is, a height direction (described in a tag 508), a final print appearance in which a sheet is folded in two and a folding position is on the right (described in a tag 509) is employed.

The estimation rule selection unit 32 selects one from among a plurality of final print appearance estimation rules stored in the estimation rule storage unit 31 on the basis of the result of the analysis obtained using the content continuity analyzer 20 and the attribute information. In accordance with the selected one of the final print appearance estimation rules, a final print appearance is estimated. Then, information of the estimated final print appearance is supplied to the print job definition data evaluation unit 7.

### Print Job Definition Data

FIG. 6 is a diagram illustrating an example of information of a final print appearance included in print job definition data obtained using the print job definition data obtaining unit 6. The print job definition data includes print job specification data which describes printing specifications, and includes print job setting data which describes settings relating to the printing apparatus. The print job definition data may be described in a markup language such as XML. In an example in FIG. 6, as a final print appearance, a final size and a final form such as a final form in which the printed material is folded in a certain way are described.

Note that the print job definition data may include information other than the information about the final print appearance.

### Hardware Configuration of Host Terminal

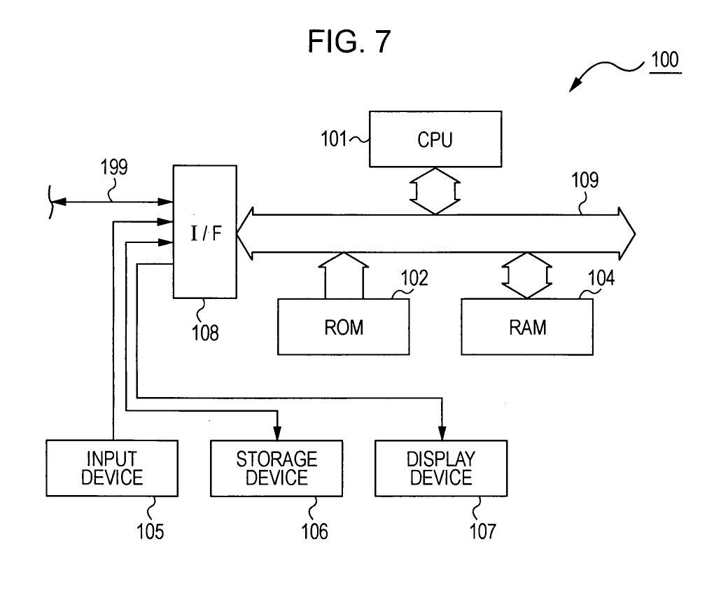

The host terminal 100 is configured as a computer having a hardware configuration as shown in FIG. 7. Operations of the units described above are realized by the host terminal 100 by performing a print support control program using the computer. Specifically, as shown in FIG. 7, the host terminal 100 includes a CPU 101, a ROM 102, a RAM 104, and an I/F 108 which are connected with one another via a bus 109 so as to transmit/receive data. The CPU 101 controls calculation and an entire system in accordance with a control program. The ROM 102 stores the control program, for example, used by the CPU 101 in a predetermined region in advance. The RAM 104 stores data read from the ROM 102, for example, and values obtained in the calculation which are used in the course of the calculation performed by the CPU 101. The I/F 108 functions as an intermediate used when the data is input from/output to external devices. The bus 109 is a signal line used to transmit the data.

As such external devices, the input device 105, a storage device 106, the display device 107, and a signal line are connected to the I/F 108. The input device 105 includes a keyboard and a mouse capable of input data as human interfaces. The storage device 106 stores data and tables, for example, as files. The display device 107 displays a screen in accordance with an image signal. The signal line is used to connect the host terminal 100 to a network 199.

### Entire Flow of Print Support System

An entire flow of the print support system having the configuration described above will now be described.

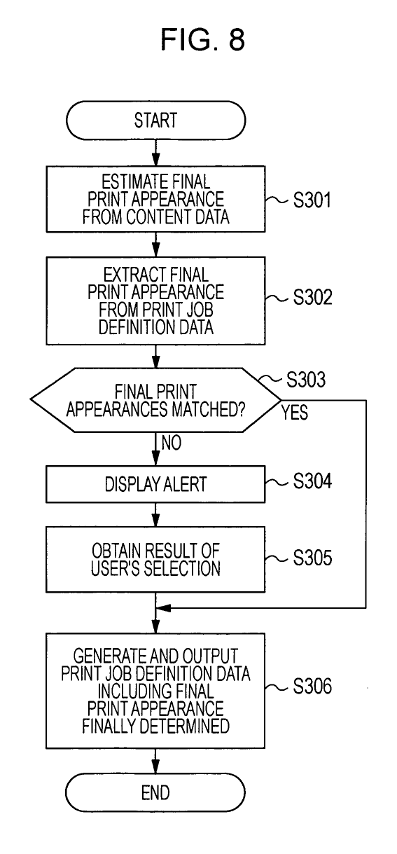

FIG. 8 is a flowchart showing an entire flow of the print support system. This flow is realized by performing the print support program according to this embodiment using the host terminal 100.

As shown in FIG. 8, the flow starts with step S301 where a first final print appearance is estimated on the basis of the content data obtained using the content data obtaining unit 1. In step S302, print job definition data associated with the content data is obtained using the print job definition data obtaining unit 6 and a second final print appearance of the content data is extracted from the print job definition data. In step S303, the first final print appearance estimated in step S301 and the second final print appearance extracted from the print job definition data in step S302 are compared with each other so that it is determined whether the first final print appearance matches the second final print appearance. When the determination is affirmative, the process proceeds to step S306, which will be described later. On the other hand, when the determination is negative, an alert is output through the user interface unit 8 in step S304 so that information about the first final print appearance and information about the second final print appearance are displayed as candidates of a selection to be made by a user. Then, a user's selection is obtained as information about a finally determined final print appearance through the user interface unit 8 in step S305, and the process proceeds to step S306.

In step S306, print job definition data including the information about the finally determined final print appearance is generated and supplied to the printing apparatus 92. For example, in a case where the finally determined final print appearance corresponds to the first final print appearance, information of a final print appearance described in a portion of the print job definition data obtained using the print job definition data obtaining unit 6 is changed to the information about the first final print appearance, and then, the print job definition data is output. The printing apparatus 92 prints the content represented by the content data so that the finally determined final print appearance obtained on the basis of the print job definition data is attained.

### EXAMPLES

Next, examples of the content data and the print job definition data will be described, and furthermore, a flow of the print support system when the print job definition data is obtained will be described.

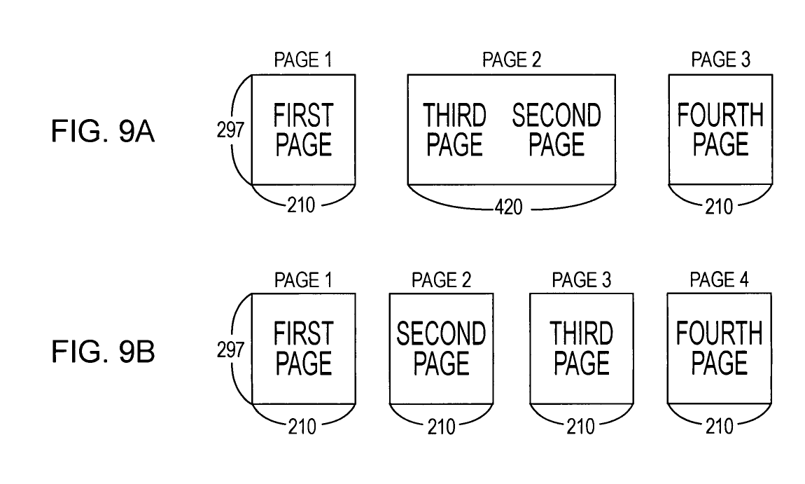

FIG. 9A shows an example of the content data, and FIG. 6 shows an example of the print job definition data. The content data shown in FIG. 9A corresponds to three pages. The size of the first page is A4, the size of the second page is A3, and the size of the third page is A4. Directions of character assemblies in the three pages are height directions. Note that numerical values such as “210” and “297” shown in the three pages represent the sizes of pages (unit is omitted). Furthermore, the print job definition data shown in FIG. 6 is associated with the content data. According to the print job definition data, the content represented by the content data is printed so as to attain the final print appearance in which a sheet is folded in two, the folding position is left, and the final size is A4 size (width 210×height 297).

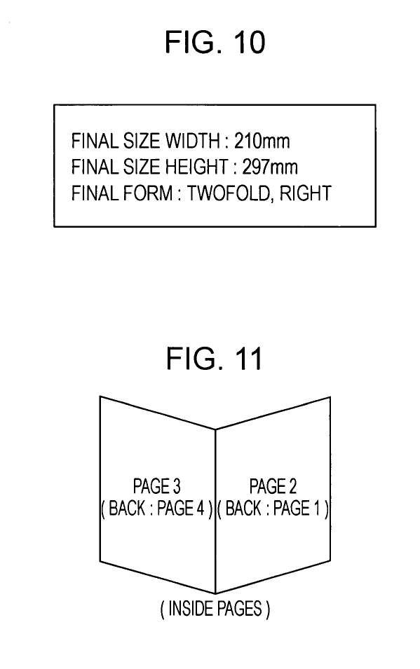

When the content data is obtained, a final print appearance is estimated on the basis of the content data in step S301 of FIG. 8. Specifically, since the content data shown in FIG. 9A corresponds to the three pages of different sizes, the preprocessing unit 11 performs the content data normalizing processing (step S103 of FIG. 3) so that the content represented by the content data corresponds to four pages of A4 size as shown in FIG. 9B. Then, the content data analyzer 10 performs the attribute information obtaining processing (step S104 of FIG. 3), the character assembly direction information obtaining processing (step S105 of FIG. 3), and the page continuity determination processing (step S106 of FIG. 3) in this order so that the number of pages, that is, four, and information about a direction of a character assembly, that is, a height direction, are obtained. Note that a pair of pages which continuously includes the content is not detected in the page continuity determination processing since such a pair of pages which has content continuity does not exist. Then, the final print appearance estimation processing (step S107 of FIG. 3) is performed on the basis of the pieces of information. In this case, since the condition of the final print appearance estimation rule shown in FIG. 5 is satisfied, a final print appearance (corresponding to the first final print appearance) shown in FIG. 10 in which a sheet is folded in two, the folding position is on the right, and the final size is A4 is estimated.

FIG. 11 shows printed material in which the first final print appearance which is estimated as described above is employed. The printed material shown in FIG. 11 is originally a sheet of an A3 size and is folded along a center line extending so as to intersect with a line extending in a longitudinal direction whereby a final size of A4 is attained. Furthermore, two-sided printing is performed on the printed material so that the first page of the content represented by the content data is printed on a front cover, the second and third pages of the content are printed on a double spread, and the fourth page of the content is printed on a back cover. The content is printed from the right page to the left page on the double spread.

Next, in step S302 of FIG. 8, the print job definition data obtaining unit 6 obtains print job definition data, and a final print appearance (corresponding to the second final print appearance) as shown in FIG. 6 is extracted. In step S303, it is determined whether the first final print appearance estimated in step S301 matches the second final print appearance extracted in step S302. In this case, since the folding position is on the right side according to the second final print appearance and a folding position is on the left side according to the first final print appearance, it is determined that the first final print appearance does not match the second final print appearance in step S303. Thereafter, information about the first final print appearance and information about the second final print appearance are displayed as candidates of a selection to be made by a user in step S304.

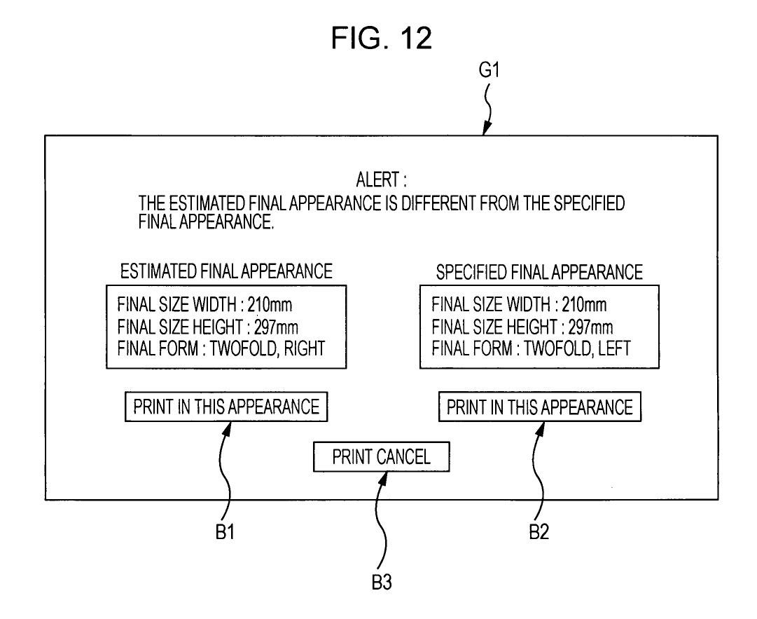

FIG. 12 shows an example of an output displayed in a screen of the display device 107. In a screen G1 of FIG. 12, the information about the first final print appearance and the information about the second final print appearance are displayed in parallel. Furthermore, selection buttons B1 to B3 are displayed so that the user determines whether printing is performed on the basis of the first final print appearance or on the basis of the second final print appearance, or whether printing is cancelled. A result of the determination made by the user is input through the input device 105.

When the result of the determination input by the user is obtained in step S305, print job definition data including information about a finally determined final print appearance selected from among the first final print appearance and the second final print appearance is generated and is output from the print job definition data generation unit 91. Note that although the print job definition data is generated using the print job definition data generation unit 91 and is output to the printing apparatus 92 in this embodiment, the print job definition data including the information about the finally determined final print appearance may be stored in a storage device, or may be distributed through a network. By this, the print job definition data may be used in the next printing operation.

### Examples of Methods for Estimating Final print appearances for Various Types of Content Data

The final print appearance estimation processing may be applied to not only the content data described above but also other types of content data. Examples of a method for estimating various final print appearances will be described hereinafter.

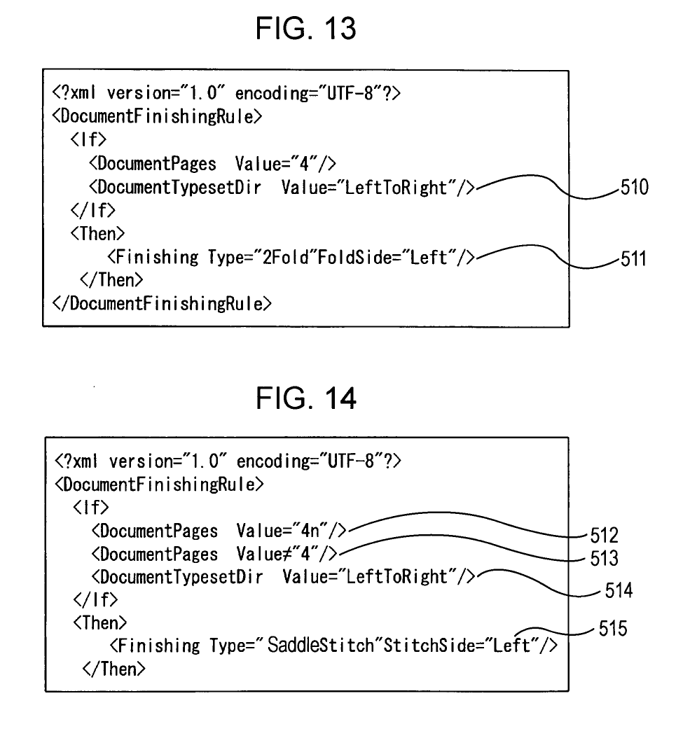

FIG. 13 and FIG. 14 show examples of final print appearance estimation rules which describe final print appearances estimated on the basis of the number of pages and information of a direction of character assembly. According to the final print appearance estimation rule shown in FIG. 13, when the number of pages is four, and a direction of the character assembly is a width direction (from left to right) (described in a tag 510), a final print appearance in which a sheet is folded in two and a folding position is left (described in a tag 511) is attained. On the other hand, according to the final print appearance estimation rule shown in FIG. 14, when the number of pages of the content represented by the content data is any multiple of four (n is an integer in FIG. 14) except for four (that is, the number of pages is any multiple of four and equal to or larger than eight) and the direction of the character assembly is the width direction, a final print appearance in which saddle stitch is applied and the folding position is on the left is attained. As described above, arrangement of pages and the number of times a sheet is folded, and a folding position, for example, can be estimated only from the number of pages and the information about the direction of the character assembly.

Next, an example of a method for estimating a final print appearance of content represented by content data when the content is continuously printed on a plurality of pages will be described.

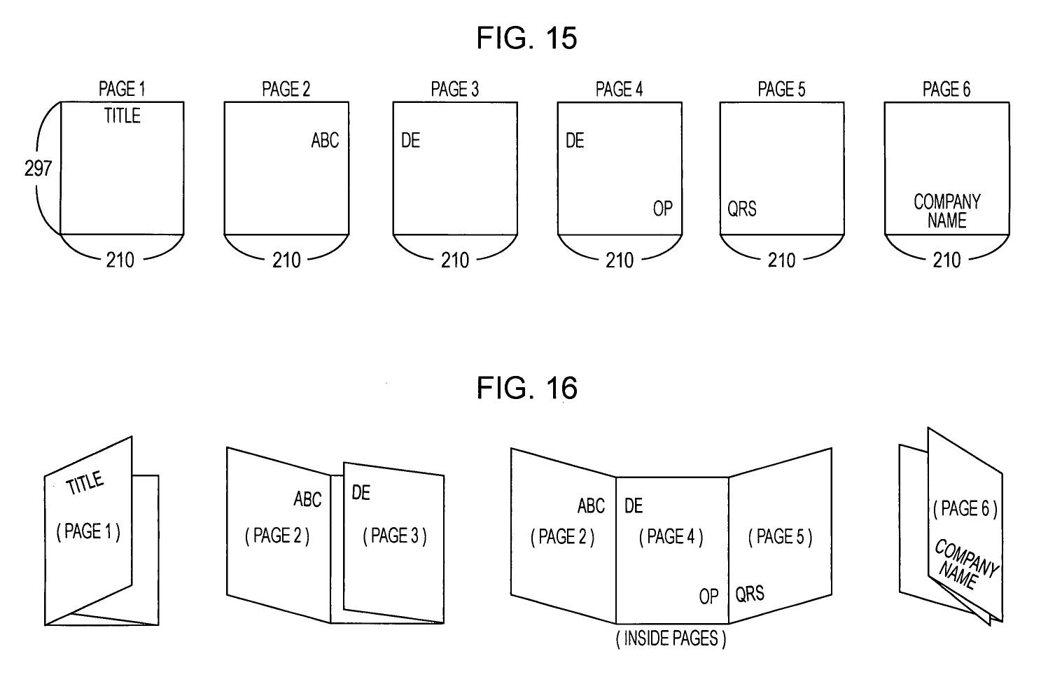

FIG. 15 shows an example of content data. The content data shown in FIG. 15 corresponds to six pages and the size of each of the pages is A4. When such content data is obtained, the attribute information obtaining processing (step S104 of FIG. 3) is performed so that information about the number of pages (six pages) is obtained. Then, the character assembly direction obtaining processing (step S105 of FIG. 3) is performed so that information about the direction of a character assembly (a width direction) is obtained. Thereafter, the page continuity determination processing (step S106 of FIG. 3) is performed. In the content data shown in FIG. 15, the context continuity determination unit 23a determines that “ABC” described in the second page is followed by both of “DE” described in the third page and “DE” described in the fourth page. Furthermore, the context continuity determination unit 23a determines that “OP” described in the fourth page is followed by “QRS” described in the fifth page. Accordingly, three pairs of pages (the second and third pages, the second and fourth pages, and the fourth and fifth pages) are obtained.

FIG. 16 shows printed material to which the first final print appearance, which is the estimated final print appearance, is applied. The printed material shown in FIG. 16 has a height which is equal to a height of a sheet of A4 size and a width which is three times larger than a width of a sheet of A4 size. The printed material is folded in three so that each face thereof is A4 size. A title is printed on a front cover, and when the front cover is opened, a character string “ABCDE” which is included in the second and third pages and which constitutes context is continuously shown on a double spread. Furthermore, when the printed material is developed, a character string “ABCDE” which is included in the second and fourth pages and a character string “OPQRS” which is included in the fourth and fifth pages are shown on the inside three pages constituting a plane so that the character strings are continuously viewed. When taking only the page sizes and the number of pages into consideration, to obtain printed material having six pages each of which has an A4 size, two-sided printing and side stitching may be performed on three A4 size sheets. However, since the three pairs of pages of the printed material have to be continuously viewed, a final print appearance which realizes such a configuration is limited.

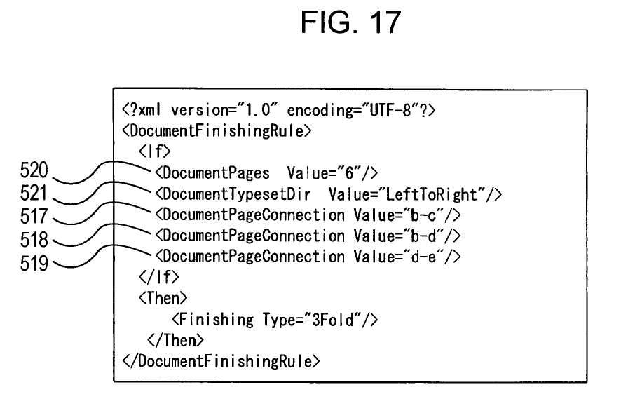

FIG. 17 shows a final print appearance estimation rule which prescribes a final print appearance of the printed material including six pages and folded in three as shown in FIG. 16. In the final print appearance estimation rule shown in FIG. 17, as conditions, the number of pages (described in a tag 520) and a direction of a character assembly (described in a tag 521) are prescribed. In addition, pairs of pages of the printed material are prescribed, each of the pairs of pages being continuously viewed from one page to another (“DocumentPageConnection” tags 517 to 519). That is, by comparing one of the pairs of pages which have continuity of the content represented by the content data with a corresponding one of the pairs of pages of printed material which is continuously viewed from one page to another, it is determined whether the one of the pairs of pages which have continuity of the content represented by the content data is realized as the one of the pairs of pages of the printed material which is continuously viewed from one page to another. In the example of FIG. 17, a pair of “b” and “c” (described in a tag 517), a pair of “b” and “d” (described in a tag 518), and a pair of “d” and “e” are prescribed as three pairs of pages. Each of the three pairs of pages is continuously viewed from one page to another.

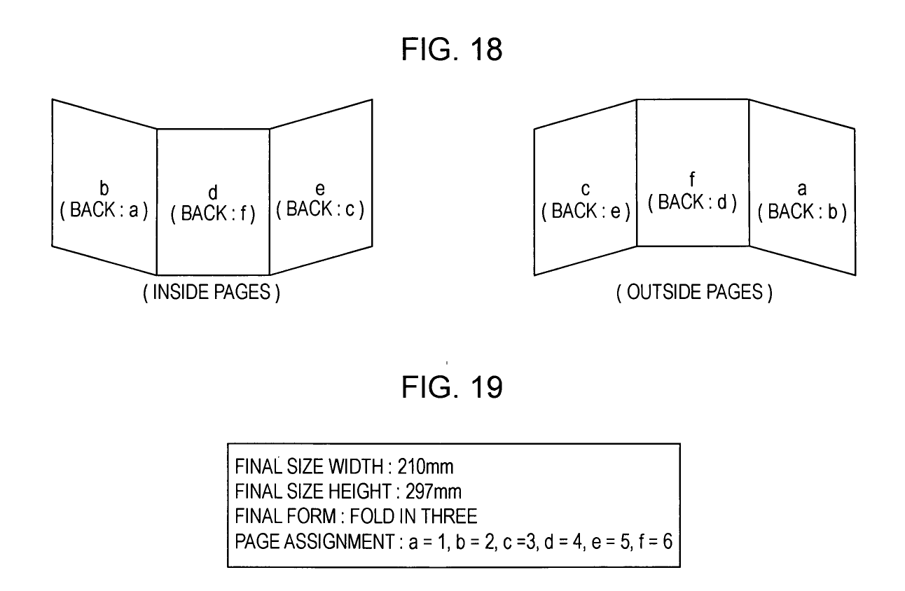

FIG. 18 shows the relationship between identifiers of pages and arrangement of pages in a case where printed material has six pages and is folded in three and a direction of a character assembly is a width direction. In FIG. 18, identifiers “b”, “d”, and “e” are assigned to inside pages of the folded printed material from the left, and identifiers “c”, “f”, and “a” are assigned to outside pages from the left in advance. The identifiers can be freely assigned to the pages, and in this embodiment, letters of the alphabet as the identifiers are assigned so that the continuity of the printed material actually viewed and the order of the alphabets coincide with each other as much as possible. That is, in a case where the direction of the character assembly is a width direction, since a left page comes before the right page, an alphabet of an earlier order is assigned to the left page in a state in which the printed material is viewed as shown in FIG. 18.

When reading the “DocumentPageConnection” tag, the estimation rule selection unit 32 performs matching between a condition prescribed by the “DocumentPageConnection” tag and a result of the determination obtained using the page continuity determination unit 23, and determines whether the each of the pairs of pages which have continuity of the content represented by the content data corresponds to a corresponding one of the pairs of pages of the printed material which is continuously viewed from one page to another. As a result, when b=2, c=3, d=4, and e=5 are satisfied, the condition of the finish print appearance estimation rule is satisfied. Accordingly, the content data shown in FIG. 15 is estimated to have the finish print appearance in which the printed material has six pages and is folded in three as shown in FIG. 18. Furthermore, the second to fifth pages of the content represented by the content data are assigned to the printed material in accordance with the associations described above.

Note that although arrangements of the pairs of pages which have continuity are determined on the basis of the matching processing using the final print appearance estimation rule as described above, arrangements of other remaining pages are not determined. Here, since the pages are arranged taking the continuity of the pairs of pages which are continuously viewed from one page to another and the order of the letters of alphabet into consideration as much as possible, pages of the content represented by the content data which have not arranged are assigned to pages of the printed material in which any page of the content is assigned in an ascending order of the page number. In this embodiment, arrangement of the first and sixth pages are determined so that a=1 and f=6 are satisfied.

FIG. 19 is a diagram illustrating an example of an output of information about a final print appearance estimated as described above. The information is output from the print final appearance estimation unit 30 to the print job definition data evaluation unit 7. The information includes a width of the final size of 210 mm, a height of the final size of 297 mm, the final form in which printed material is folded in three, and assignment of pages assigned so that a=1, b=2, c=3, d=4, e=5, and f=6 are satisfied.

Since pairs of pages of the content represented by the content data which have content continuity (that is, context continuity, in this embodiment) are determined, a specific final print appearance in which each of the pairs of pages which have content continuity is continuously viewed from one page to another is estimated.

Next, an example of estimating a final print appearance of the content represented by the content data which includes a plurality of pages which continuously includes an image will be described.

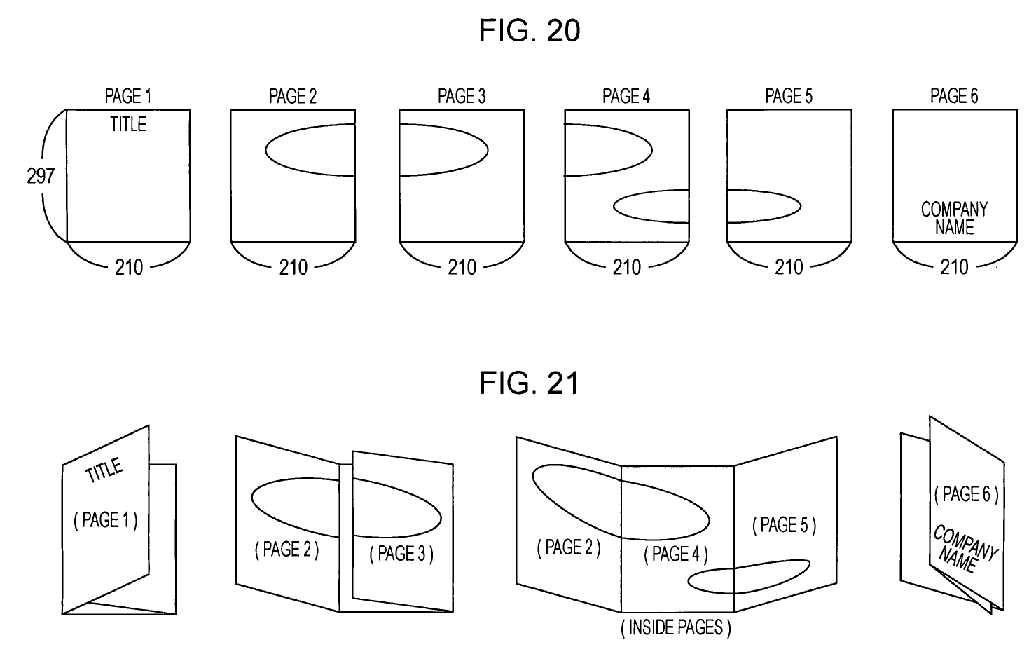

FIG. 20 shows an example of content data. As with the content data shown in FIG. 15, the content data shown in FIG. 20 represents content which includes six pages each of which is A4 size. However, the content data shown in FIG. 20 is different from the content data shown in FIG. 15 in that some pairs of pages have image continuity instead of context continuity. Descriptions of operations the same as those performed on the content data shown in FIG. 15 are omitted and operations different from those performed on the content data shown in FIG. 15 are mainly described.

When obtaining the content data show in FIG. 20, the host terminal 100 obtains information about the number of pages (six pages) through the attribute information obtaining processing (step S104 of FIG. 3), obtains information about a direction of a character assembly (a width direction) through the character assembly direction obtaining processing (step S105 of FIG. 3), and performs the page continuity determination processing (step S106 of FIG. 3). In the content data shown in FIG. 20, the image continuity determination unit 23b compares gradation histograms of areas in the vicinity of edges in the width direction of the pages with one another, and three pairs of page numbers (2 and 3, 2 and 4, and 4 and 5) which have continuity are detected. Accordingly, a result of determination obtained using the page continuity determination unit 23 in a case of the content data shown in FIG. 20 is the same as the result of the determination obtained in a case of the content data shown in FIG. 15. Therefore, the information about a direction of a character assembly and the attribute information are same as those in the case of the content data shown in FIG. 15. Consequently, the final print appearance estimation rule shown in FIG. 17 is employed so that printed material is folded in three and has six pages. In addition, arrangement of the pages is determined so that a=1, b=2, c=3, d=4, e=5, and f=6 are satisfied.

FIG. 21 shows printed material to which the estimated final print appearance is applied. The printed material shown in FIG. 21 attains the final print appearance in which the final size is A4, the printed material is folded in three, and the number of pages is six. A first image included in the second and third pages of the content are shown on a double spread so as to be continuously viewed from one page to another. When the printed material is developed, a second image included in the second and fourth pages of the content and a third image included the fourth and fifth pages of the content are shown on the inside three pages constituting a plane so that each of the second and third images is continuously viewed.

As described, pairs of pages which have content continuity are detected by making use of not only the context continuity but also image continuity. By this, a final print appearance in which each of the pairs of pages which have content continuity can be continuously viewed from one page to another is estimated.

Next, an example of estimating a final print appearance of the content represented by the content data in which pairs of pages which have content continuity are generated after the content data normalizing processing is performed is described.

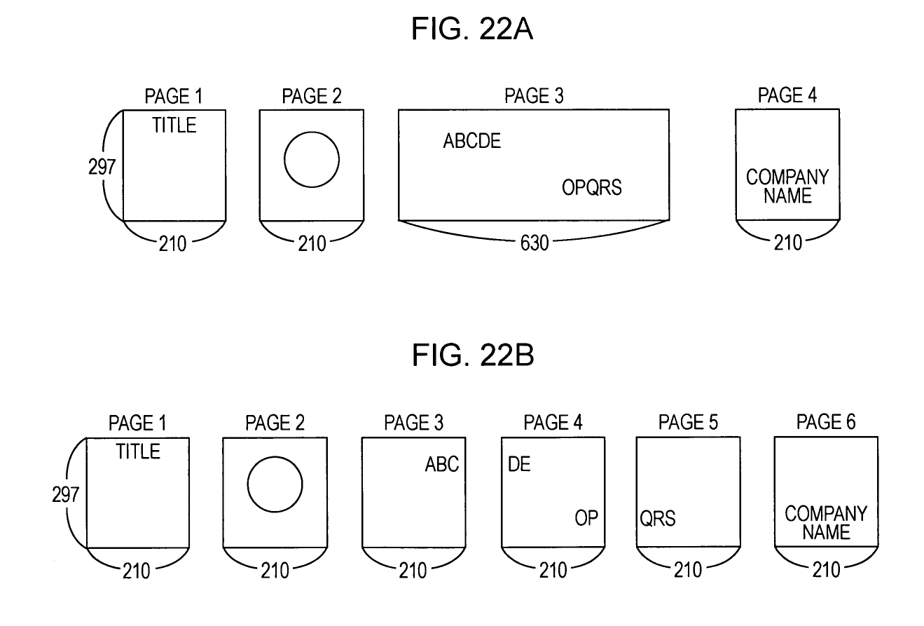

FIG. 22A shows an example of content data. In content represented by the content data shown in FIG. 22A, four pages of different sizes are mixed.

When the host terminal 100 obtains the content data, since the pages of different sizes are mixed, the preprocessing unit 11 performs processing on all pages to obtain a reference size. Since A4 is the smallest size, A4 is set as the reference size (step S102 of FIG. 3) and the content data normalizing processing is performed. Since the third page has a width of three times larger than the width of the reference size (in step S203 of FIG. 4: Yes) and the direction of the character assembly is the width direction (in step S204 of FIG. 4: width direction), the third page is divided into three in the width direction and the divided three pages are set as the third page, the fourth page, and the fifth page from the left (in step S206 of FIG. 4). Accordingly, the content having six pages of A4 size are obtained as shown in FIG. 22B through the content data normalizing processing.

After the preprocessing unit 11 performs the processing, the attribute information obtaining processing (step S104 of FIG. 3) and the character assembly direction information obtaining processing (step S105 of FIG. 3) are performed in this order so that information about the number of pages (six) and information about the direction of the character assembly (width direction) are obtained. Next, the page continuity determination unit 23 performs the page continuity determination processing (step S106 of FIG. 3). Specifically, the page continuity determination unit 23 determines that, in the content represented by the content data, each of a pair of the third and fourth pages and a pair of the fourth and fifth pages has continuity. (Since a direction of the continuity of the pair of the third and fourth pages coincides with a direction of the continuity of the pair of the fourth and fifth pages, the third, fourth, and fifth pages are output in this order.)

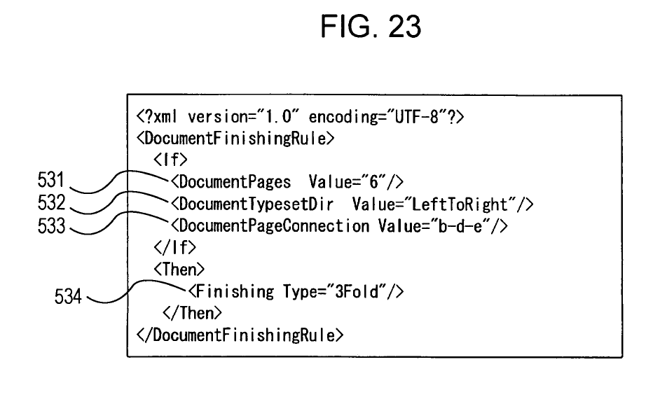

FIG. 23 shows a final print appearance estimation rule which is to be applied to the content data shown in FIG. 22A. The finish print appearance estimation rule of FIG. 23 prescribes, as conditions, the rules in which the number of pages is six pages (in a tag 531), the direction of the character assembly is the width direction (in a tag 532), and the pairs of pages, each of which is continuously viewed from one page to another, have identifiers of b and d, and d and e (in a tag 533).

After determining that the obtained number of pages and the obtained direction of the character string coincide with those described in the final print appearance, the estimation rule selection unit 32 reads the “DocumentPageConnection” tag, and performs matching between the conditions prescribed by the “DocumentPageConnection” tag and the result of the determination obtained using the page continuity determination unit 23. As a result, the conditions are satisfied since the identifier b corresponds to the third page, the identifier d corresponds to the fourth page, and the identifier e corresponds to the fifth page, it is determined that the final print appearance in which the printed material is folded in three which is described in a tag 534 can be employed, and arrangement of the third to fifth pages is determined. Furthermore, pages of the content represented by the content data which have not arranged are assigned to the other remaining pages of the printed material in which any page of the content is assigned in an ascending order of the page number as described above. In this embodiment, arrangement of the first, second, and sixth pages are determined so that a=1, c=2, and f=6 are satisfied.

The print final appearance estimation unit 30 outputs a result of the estimation of the final print appearance which includes information including a width of the final size of 210 mm, a height of the final size of 297 mm, and assignment of pages which satisfies a=1, b=3, c=2, d=4, e=5, and f=6 to the print job definition data evaluation unit 7.

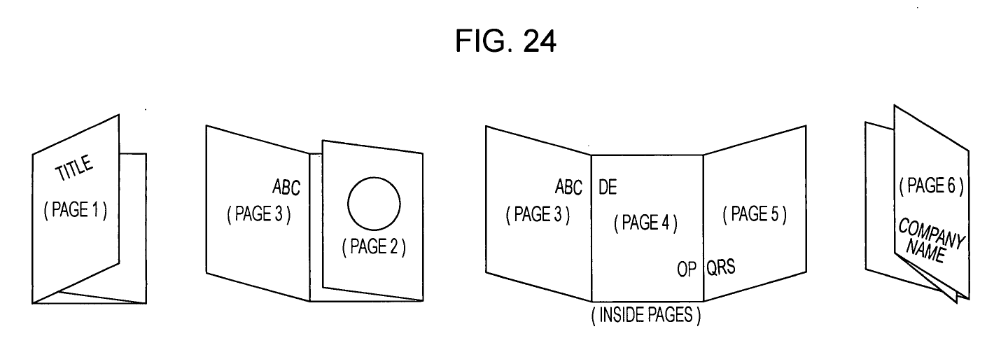

FIG. 24 shows printed material to which the estimated final print appearance is applied. The printed material shown in FIG. 24 is folded in three so as to obtain six pages and each face thereof is A4 size. A title is printed on a front cover, and when the printed material is developed, a character string “ABCDE” which is included in the third and fourth pages and a character string “OPQRS” which is included in the fourth and fifth pages are shown on the inside three pages constituting a plane so that the character strings are continuously viewed.

With this configuration of this embodiment, the content data obtained using the content data obtaining unit 1 is analyzed using the content data analyzer 10, a final print appearance is estimated on the basis of a result of the analysis, a determination is made as to whether a final print appearance included as information in the print job definition data matches the estimated final print appearance, and outputs an alert for a user when the determination is negative so that an appropriate final print appearance is selected by the user. Accordingly, the content represented by the content data is printed with the appropriate final print appearance. Furthermore, since continuity of the content is analyzed when the content data is analyzed, a final print appearance including a form in which the printed material is folded in a certain way is reproduced on the basis of the content data arranged in a plane.

### Modifications

The present invention is not limited to the embodiment described above.

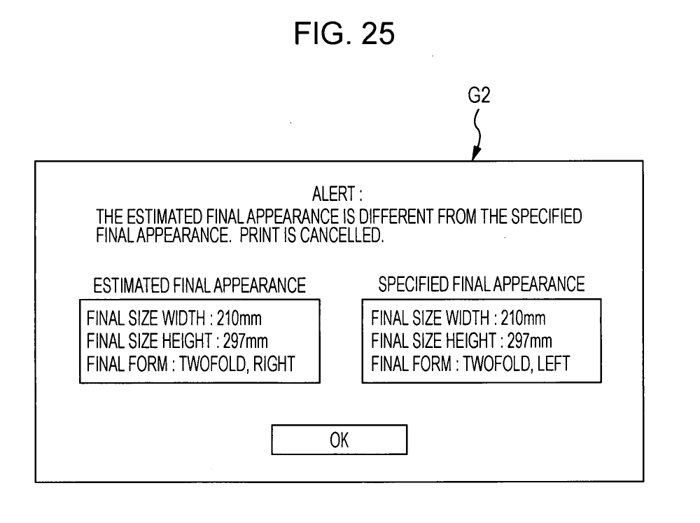

FIG. 25 shows an example of an output displayed in a screen of a display device 107. In a screen G2 shown in FIG. 25, an estimated final print appearance and a final print appearance prescribed in print job definition data are displayed in parallel, and furthermore, an alert notifying the user of cancellation of printing is displayed. In this case, the content represented by the content data is not printed and the process is terminated. Accordingly, the content is prevented from printing with an inappropriate final print appearance. Alternatively, after the alert is displayed, the printing operation may be performed by forcibly selecting a final print appearance among the estimated final print appearance, the prescribed final print appearance, and other appropriate final print appearances. Furthermore, although in FIGS. 12 and 25, the final print appearances are displayed in the screens as text, a final print appearance may be displayed as an image so that user can clearly recognize it. Moreover, in a case where a plurality of final print appearances are estimated, the plurality of final print appearances may be displayed as candidates of a selection. In addition, a user interface used to output an alert is not limited to the display device 107, and the alert may be output as sound from a speaker, for example.

Furthermore, content data is not limited to content data described by the page description language. For example, when content data which is image data representing content of the JPEG format or the TIFF format is input, sizes of pages may be calculated using a size of the image data (the number of pixels arranged in a matrix) and resolution information (for example, 300 dpi) described in a header portion.

Furthermore, for example, a configuration in which the host terminal 100 does not include character assembly direction information obtaining unit 22 in the content continuity analyzer 20 but includes only the page continuity determination unit 23 may be employed. In this case, for example, when an image is printed on a plurality of pages so as to have continuity as shown in FIG. 20, the page continuity determination unit 23 determines folding positions by determining a direction (from left to right, from right to left, or from top to bottom) of the continuity of the image included in the plurality of pages. Similarly, in a case where the host terminal 100 does not include the page continuity determination unit 23 but includes only the character assembly direction information obtaining unit 22, folding positions (binding positions) are determined. Accordingly, the final print appearance of the content data as shown in FIG. 9A, for example, may be estimated. Furthermore, the context continuity determination unit 23a or the image continuity determination unit 23b may function as the page continuity determination unit 23.

Moreover, in case where information about a direction of a character assembly is not included in content data, the host terminal 100 may include a character assembly direction determination unit used to determine the direction of a character assembly on the basis of the content data. Specifically, in a case where the content data includes the information about a direction of a character assembly, the character assembly direction determination unit obtains the information about a direction of a character assembly and outputs the information to the character assembly direction information obtaining unit 22. Furthermore, in a case where the content data does not include information about a direction of a character assembly but includes a description about character codes and arrangement positions of characters in a character unit, the direction of the character assembly is determined using the relationship between positions of the characters successively printed in accordance with character printing instructions successively supplied. Note that the direction of a character assembly is reliably determined by performing a syntax analysis on the character codes of the characters printed in accordance with the character printing instructions successively supplied so that it is determined that the characters have continuity and constitute the character string.

### First Configuration

A print support system which supports a printing operation of printing content represented by content data so that a final print appearance suitable for the content data is attained. The print support system includes, a content data obtaining unit configured to obtain the content data, a print job definition data obtaining unit configured to obtain print job definition data including information about a first final print appearance of the content data, a final print appearance estimation unit configured to estimate information about a second final print appearance of the content data on the basis of the content data obtained using the content data obtaining unit, and a print job definition data evaluation unit configured to determine whether the information about the first final print appearance included in the print job definition data obtained using the print job definition data obtaining unit matches the information about the second final print appearance estimated using the final print appearance estimation unit, and configured to output an alert through a user interface when mismatch between the information about the first final print appearance and the information about the second final print appearance is detected.

With this configuration, the first final print appearance is estimated using the content data, and a determination is made as to whether the information about the first final print appearance included in the print job definition data matches the information about the second final print appearance estimated using the final print appearance estimation unit, and an alert is output through a user interface when mismatch between the information about the first final print appearance and the information about the second final print appearance is detected. Accordingly, even when wrong print job definition data is supplied, an appropriate final print appearance is attained.

The content data obtaining unit may have any configuration as long as the content data obtaining unit can obtain content data. For example, the content data obtaining unit may obtains content data from an input device, for example, may obtains or receives content data from an external device, for example, and may read content data from a storage device or a storage medium, for example. Accordingly, the content data obtaining unit has an obtaining function in which the content data is at least input, obtained, received, or read by the content data obtaining unit. The attribute information obtaining unit for example, has the same obtaining function.

Furthermore, the final print appearance is a final form of printed material obtained through print preprocessing (a prepress operation), printing processing (a press operation), and print post-pressing (a postpress operation).

For example, the final print appearance is a final form of printed material which includes a final size, and a final folding way of the printed material obtained through a series of printing operations. The series of printing operations includes a prepress operation such as plate making, and imposition, a press operation which is a narrowly defined printing operation using a printing apparatus, and a postpress operation including folding, cutting, binding of a printed sheet.

Furthermore, the print job definition data includes information about a printing job, and includes, at least in this configuration, information about a final print appearance which is used to control a printing operation for printing content represented by content data. Note that desired specifications of printed material as a final product may be described in the print job definition data or settings of the printing apparatus may be described in the print job definition data. Example of the print job definition data in which the final print appearance is described includes data including information about a final size (a final size of printed material). Specifically, such print job definition data includes, for example, information about a size of a sheet using at a time of imposition (processing of assigning a plurality of pages to one side of a sheet so that the final size is attained by folding and cutting the sheet), information about a method of imposition, precise coordinates information at the time of imposition, information about a folding way, and information about a cutting position. Some of pieces of setting data included in the print job definition data may coincide with pieces of data included in print job specification data.

Furthermore, in the specification, claims, and drawings, a user interface represents an input/output device, such as a display device, a speaker, and a keyboard, which are used to output information for a user and which are used to receive an input from the user. Although the user interface should include at least an output function in the first configuration, the user interface should include an input function in a second configuration, which will be described later.

Note that this system may be realized using a single apparatus, a single terminal, or a single device. Alternatively, this system may be realized as a network system employing a plurality of apparatuses, a plurality of terminals, or a plurality of devices, which are connected to one another. In the latter case, the components of the embodiment may be included in any of the plurality of apparatuses, a plurality of terminals, or a plurality of devices, as long as the components are connected to one another so as to communicate with one another.

### Second Configuration

A print support system according to a second configuration includes, in addition to the units of the first configuration, a print job definition data generation unit configured to generate, when the print job definition data evaluation unit outputs the information about the first final print appearance and the information about the second final print appearance as candidates of a selection through the user interface when the mismatch between the information about the first final print appearance and the information about the second final print appearance is detected, print job definition data including one from among the information about the first final print appearance and the information about the second final print appearance inputted as a result of the selection.

With this configuration, the user can select an appropriate one from among the estimated second final print appearance and the first final print appearance included in the print job definition data. Since print job definition data is generated in accordance with this selection, content is printed so as to attain the appropriate final print appearance.

The print job definition data generated in this configuration includes, as with the print job definition data obtained using the print job definition data obtaining unit, print job specification data and print job setting data.

### Third Configuration

In addition to the first and second configurations, in a print support system according to a third configuration, the final print appearance estimation unit estimates the second final print appearance in accordance with content continuity of the content representing the content data obtained using the content data obtaining unit.

Since the content continuity is examined, arrangement of pages (a page structure) of the printed material on which the content is printed can be estimated. Accordingly, since the arrangement of pages of the printed material attaining a complicated final print appearance including a folding way of the pages is realized on the basis of the content data representing the content in which pages are merely arranged in a plane or the pages are not even arranged, an appropriate estimation can be performed.

Furthermore, the estimation performed “in accordance with content continuity” means estimation of a final print appearance performed by examining the continuity of the content in a plurality of pages and a state of the content continuity. The state of the content continuity includes a direction of the content continuity in the pages, and includes, in a case where the content is continuously included in the plurality of pages, information about pages continuously includes the content and a direction of the continuity of the content included in the plurality of pages. The direction of the content continuity includes a direction from a left page to a right page, a direction from the right page to the left page, and a direction from top to bottom, for example.

### Fourth Configuration

In addition to the third configuration, the print support system according to a fourth configuration includes an attribute information obtaining unit configured to obtain attribute information of the content data, the attribute information including at least the number of pages of the content represented by the content data. The final print appearance estimation unit refers to the attribute information obtained using the attribute information obtaining unit and estimates the final print appearance of the content data, the final print appearance including at least information about arrangement of pages of printed material and information about the relationship between the pages of the printed material and the pages of the content represented by the content data.

With this configuration, the arrangement of all pages of the printed material is estimated on the basis of the attribute information of the entire content data such as the number of pages of the content represented by the content data and information about the relationship between all pages or between specific pages.

Accordingly, since the arrangement of pages of the printed material attaining a complicated final print appearance including a folding way of the pages is realized on the basis of the content data representing the content in which pages are merely arranged in a plane or the pages are not even arranged, printed material of an appropriate final print appearance can be obtained.

Note that, the arrangement of pages of the printed material indicates a configuration of pages of the printed material which represents the relationship between the pages of the printed materials. Furthermore, the arrangement of pages of the printed material is determined on the basis of a binding way, a folding way, and the number of pages of the printed material.

Note that, examples of the attribute information of the content data includes sizes of pages of the content represented by the content data and a direction. The direction indicates a direction of a longitudinal side of each of the pages selected from among a vertical direction, a horizontal direction, or an oblique direction. For example, in a case where one of the pages is A4 size, it is determined whether a longitudinal side of the one of the pages extends in the vertical direction (that is, a vertically wide page) or in the horizontal direction (that is, a horizontally wide page).

### Fifth Configuration

In addition to the third and fourth configurations, a print support system according to a fifth configuration includes a character assembly direction information obtaining unit configured to obtain information about a direction of a character assembly in the pages of the content represented by the content data. The final print appearance estimation unit estimates the second final print appearance including a binding position of the content represented by the content data on the basis of the information about a direction of a character assembly obtained using the character assembly direction information obtaining unit.

With this configuration, in accordance with the direction of a character assembly, binding positions of the pages (the binding positions indicates sides of the pages to be turned over and folding positions) are determined and the second final print appearance of the content represented by the content data is estimated. Accordingly, since the arrangement of pages of the printed material attaining a complicated final print appearance including a folding way of the pages is realized on the basis of the content data representing the content in which the pages are merely arranged in a plane or the pages are not even arranged, printed material of an appropriate final print appearance can be obtained.

### Sixth Configuration

In addition to the fifth configuration, a print support system according to a sixth configuration includes a character assembly direction determination unit configured to determine the direction of the character assembly on the basis of arrangement of characters which have continuity and which are included in the pages of the content represented by the content data obtained using the content data obtaining unit. The character assembly direction information obtaining unit obtains a result of the determination made by the character assembly direction determination unit as information about the direction of the character assembly.

With this configuration, even in a case where the content data does not include the information about the direction of the character assembly, the information about the direction of the character assembly can be obtained by analyzing the content data whereby the final print appearance can be estimated.

### Seventh Configuration

In addition to the any one of the third to sixth configuration, a print support system according to a seventh configuration includes a page continuity determination unit configured to detect a pair of pages which has content continuity among the pages of the content represented by the content data. The final print appearance estimation unit estimates the final print appearance of the content represented by the content data so that the pair of pages determined to have continuity using the page continuity determination unit is continuously viewed from one page to another in the printed material.

With this configuration, the continuity of the pages of the printed material, which is not detected from the page numbers of the content represented by the content data, can be detected. Accordingly, a final print appearance realizing the continuity is estimated.

Accordingly, since the arrangement of pages of the printed material attaining a complicated final print appearance including a folding way of the pages is realized on the basis of the content data representing the content in which the pages are merely arranged in a plane or the pages are not even arranged, printed material of an appropriate final print appearance can be obtained.

Note that, a state in which “the pair of pages determined to have continuity using the page continuity determination unit is continuously viewed from one page to another in the printed material” is realized by arranging the pair of pages determined to have content continuity so that one of the pair of pages is arranged on a first surface of a sheet and the other one of the pair of pages is arranged on a second surface of the sheet, or by arranging the pair of pages determined to have content continuity on a plane which appears when the folded printed material is developed, for example.

In a case where a plurality of pairs of pages which have continuity are detected, a final print appearance which realizes continuity of a plurality of pairs of pages of the printed material is estimated on the basis of the plurality of pairs of pages of the content represented by the content data.

### Eighth Configuration

In addition to the seventh configuration, in a print support system according to a eighth configuration, the page continuity determination unit includes a context continuity determination unit configured to determine whether character strings included in the plurality of pages of the content represented by the content data have continuity in context, and a pair of pages determined to have continuity in context is determined to be a pair of pages having content continuity.

With this configuration, in a case where the content includes characters, a pair of pages having continuity is detected by comparing sentences included in the paragraphs in the same position of the pair of pages and character strings included in the sentences in the same positions of the pair of pages. Accordingly, since, although information about arrangement of the pages of the content represented by the content data is lacked, information about arrangement of the pages of the printed material is obtained, an appropriate result of printing can be obtained. The arrangement of the pages includes a folding way of the pages. Note that in accordance with the direction of content continuity, a direction of the pairs of pages (sides of the pages to be turned over and binding positions) are determined.

### Ninth Configuration

In addition to the seventh and eighth configurations, in a print support system according to a ninth configuration, the page continuity determination unit includes an image continuity determination unit configured to determine whether images included in the plurality of pages of the content represented by the content data are images in continuous regions constituting a single image.

With this configuration, in a case where the content includes an image, a pair of pages having continuity is detected by determining whether images included in the plurality of pages of the content represented by the content data are images in continuous regions constituting a single image. Accordingly, since, although information about arrangement of the pages of the content represented by the content data is lacked, information about arrangement of the pages of the printed material is obtained, an appropriate result of printing can be obtained. The arrangement of the pages includes a folding way of the pages. Note that in accordance with the direction of image continuity, a direction of the pairs of pages (sides of the pages to be turned over and binding positions) are determined.

### Tenth Configuration

A print support program according to a tenth configuration supports a printing operation of printing content represented by content data so that a final print appearance suitable for the content data is attained. The print support program makes a computer obtain the content data, obtain print job definition data including information about a first final print appearance of the content data, estimate information about a second final print appearance of the content data on the basis of the obtained content data, determine whether the information about the first final print appearance included in the print job definition data obtained using the print job definition data obtaining unit matches the information about the second final print appearance estimated using the final print appearance estimation unit, and output an alert through a user interface when mismatch between the information about the first final print appearance and the information about the second final print appearance is detected.

With this configuration, the computer reads the program, and when the computer performs processing in accordance with the read program, an operation and an advantage similar to those obtained in the print support system according to the first configuration is attained.

### Eleventh Configuration

In addition to the tenth configuration, in a print support program according to an eleventh configuration, when it is determined that mismatch between the information about the first final print appearance and the information about the second final print appearance is detected, the information about the first final print appearance and the information about the second final print appearance are output as candidates of a selection through a user interface, and print job definition data including one from among the information about the first final print appearance and the information about the second final print appearance which is inputted as a result of the selection is generated.

With this configuration, the computer reads the program, and when the computer performs processing in accordance with the read program, an operation and an advantage similar to those obtained in the print support system according to the second configuration is attained.

### Twelfth Configuration

In addition to the tenth and eleventh configurations, in a print support program according to a twelfth configuration, the final print appearance of the content data is estimated on the basis of content continuity of the content data obtained using the content data obtaining unit.

With this configuration, the computer reads the program, and when the computer performs processing in accordance with the read program, an operation and an advantage similar to those obtained in the print support system according to the third configuration is attained.

### Thirteenth Configuration

In addition to the twelfth configuration, in a print support program according to a third configuration, an attribute information of the content data including at least the number of pages of the content represented by the content data is obtained on the basis of the obtained content data, and the final print appearance including at least information about arrangement of pages of printed material and information about the relationship between the pages of the printed material and the pages of the content represented by the content data is estimated with reference to the obtained attribute information.

With this configuration, the computer reads the program, and when the computer performs processing in accordance with the read program, an operation and an advantage similar to those obtained in the print support system according to the fourth configuration is attained.

### Fourteenth Configuration

In addition to the twelfth and thirteenth configurations, in a print support program according to a fourth configuration, information about a direction of a character assembly which is a direction of character continuity in the pages of the content represented by the content data is obtained, and a final print appearance including a binding position of the content represented by the content data is estimated on the basis of the obtained information about the direction of the character assembly.

With this configuration, the computer reads the program, and when the computer performs processing in accordance with the read program, an operation and an advantage similar to those obtained in the print support system according to the fifth configuration is attained.

### Fifteenth Configuration

In addition to the fourteenth configuration, in a print support program according to a fifteenth configuration, the direction of the character assembly is determined on the basis of the relationship between arrangement positions of characters which have continuity and which are included in the content represented by content data, and a result of the determination is obtained as information about the direction of the character assembly.

With this configuration, the computer reads the program, and when the computer performs processing in accordance with the read program, an operation and an advantage similar to those obtained in the print support system according to the sixth configuration is attained.

### Sixteenth Configuration

In addition to any of the twelfth to fifteenth configurations, in a print support program according to a sixteenth configuration, a pair of pages which has content continuity among the pages of the content represented by the content data is detected, and the final print appearance of the content represented by the content data is estimated so that the pair of pages determined to have continuity using the page continuity determination unit is continuously viewed from one page to another in the printed material.

With this configuration, the computer reads the program, and when the computer performs processing in accordance with the read program, an operation and an advantage similar to those obtained in the print support system according to the seventh configuration is attained.

### Seventeenth Configuration

In addition to the sixteenth configuration, a print support program according to a seventeenth configuration includes a context continuity determination unit configured to determine whether character strings included in the plurality of pages of the content represented by the content data have continuity in context, and a pair of pages determined to have continuity in context is determined to be a pair of pages having content continuity.

With this configuration, the computer reads the program, and when the computer performs processing in accordance with the read program, an operation and an advantage similar to those obtained in the print support system according to the eighth configuration is attained.

### Eighteenth Configuration

In addition to the sixteenth or seventeenth configuration, in a print support program according to a eighteenth configuration, a determination is made as to whether images included in the plurality of pages of the content represented by the content data are images in continuous regions constituting a single image, and a pair of pages determined to have images in continuous regions is determined to be a pair of pages having content continuity.

With this configuration, the computer reads the program, and when the computer performs processing in accordance with the read program, an operation and an advantage similar to those obtained in the print support system according to the ninth configuration is attained.

### Nineteenth Configuration

In a print support method according to a nineteenth configuration for supporting a printing operation of printing content represented by content data so that a final print appearance suitable for the content data is attained, the content data is obtained, print job definition data including information about a first final print appearance of the content data is obtained, information about a second final print appearance of the content data is estimated on the basis of the obtained content data, and a determination is made as to whether the information about the first final print appearance included in the print job definition data obtained using the print job definition data obtaining unit matches the information about the second final print appearance estimated using the final print appearance estimation unit, and when it is determined that mismatch between the information about the first final print appearance and the information about the second final print appearance is detected, an alert is output through a user interface.

With this configuration, an operation and an advantage similar to those obtained in the print support system according to the first configuration is attained.

### Twentieth Configuration

In addition to the nineteenth configuration, in a print support method according to a twentieth configuration, when it is determined that mismatch between the information about the first final print appearance and the information about the second final print appearance is detected, the information about the first final print appearance and the information about the second final print appearance are output as candidates of a selection through a user interface, and print job definition data including one from among the information about the first final print appearance and the information about the second final print appearance which is inputted as a result of the selection is generated.

With this configuration, an operation and an advantage similar to those obtained in the print support system according to the second configuration is attained.

### Twenty First Configuration

In addition to the nineteenth or twentieth configuration, in a print support method according to a twenty first configuration, the final print appearance of the content data is estimated on the basis of content continuity of the obtained content data.

With this configuration, an operation and an advantage similar to those obtained in the print support system according to the third configuration is attained.

### Twenty Second Configuration

In addition to the twenty first configuration, in a print support program according to a twenty second configuration, an attribute information of the content data including at least the number of pages of the content represented by the content data is obtained on the basis of the obtained content data, and the final print appearance including at least information about arrangement of pages of printed material and information about the relationship between the pages of the printed material and the pages of the content represented by the content data is estimated with reference to the obtained attribute information.

With this configuration, an operation and an advantage similar to those obtained in the print support system according to the fourth configuration is attained.

### Twenty Third Configuration

In addition to the twenty first and twenty second configurations, in a print support program according to a twenty third configuration, information about a direction of a character assembly which is a direction of character continuity in the pages of the content represented by the content data is obtained, and a final print appearance including a binding position of the content represented by the content data is estimated on the basis of the obtained information about the direction of the character assembly.

With this configuration, an operation and an advantage similar to those obtained in the print support system according to the fifth configuration is attained.

### Twenty Fourth Configuration

In addition to the twenty third configuration, in a print support method according to a twenty fourth configuration, the direction of the character assembly is determined on the basis of the relationship between arrangement positions of characters which have continuity and which are included in the content represented by content data, and a result of the determination is obtained as information about the direction of the character assembly.

With this configuration, an operation and an advantage similar to those obtained in the print support system according to the sixth configuration is attained.

### Twenty Fifth Configuration

In addition to any of the twenty first to twenty fourth configurations, in a print support method according to a twenty fifth configuration, a pair of pages which has content continuity among the pages of the content represented by the content data is detected, and the final print appearance of the content represented by the content data is estimated so that the pair of pages determined to have continuity using the page continuity determination unit is continuously viewed from one page to another in the printed material.

With this configuration, an operation and an advantage similar to those obtained in the print support system according to the seventh configuration is attained.

### Twenty Sixth Configuration

In addition to the twenty fifth configuration, in a print support program according to a twenty sixth configuration, a determination is made as to whether character strings included in the plurality of pages of the content represented by the content data have continuity in context, and a pair of pages determined to have continuity in context is determined to be a pair of pages having content continuity.

With this configuration, an operation and an advantage similar to those obtained in the print support system according to the eighth configuration is attained.

### Seventh Configuration

In addition to the twenty fifth or twenty sixth configuration, in a print support program according to a twenty seventh configuration, a determination is made as to whether images included in the plurality of pages of the content represented by the content data are images in continuous regions constituting a single image, and a pair of pages determined to have images in continuous regions is determined to be a pair of pages having content continuity.

With this configuration, an operation and an advantage similar to those obtained in the print support system according to the ninth configuration is attained.

What is claimed is:

1. A print support system which supports a printing operation of printing content represented by content data having a plurality of pages so that a final print appearance suitable for the content data is attained, the print support system comprising:
a content data obtaining unit configured to obtain the content data; and
a final print appearance estimation unit configured to estimate the final print appearance of the content data on the basis of content continuity of the content represented by the content data obtained using the content data obtaining unit.

2. The print support system according to claim 1, further comprising:
an attribute information obtaining unit configured to obtain attribute information of the content data, the attribute information including at least the number of pages of the content represented by the content data,
wherein the final print appearance estimation unit refers to the attribute information obtained using the attribute information obtaining unit and estimates the final print appearance of the content data, the final print appearance including at least information about arrangement of pages of printed material and information about a relationship between the pages of the printed material and the pages of the content represented by the content data.

3. The print support system according to claim 2, further comprising,
a page continuity determination unit configured to detect a pair of pages which has content continuity among the pages of the content represented by the content data,
wherein the final print appearance estimation unit estimates the final print appearance of the content represented by the content data so that the pair of pages determined to have continuity using the page continuity determination unit is continuously viewed from one page to another in the printed material.

4. The print support system according to claim 3,
wherein the page continuity determination unit includes a context continuity determination unit configured to determine whether character strings included in the plurality of pages of the content represented by the content data have continuity in context, and a pair of pages determined to have continuity in context is determined to be a pair of pages having content continuity.

5. The print support system according to claim 3,
wherein the page continuity determination unit includes an image continuity determination unit configured to determine whether images included in the plurality of pages of the content represented by the content data are images in continuous regions constituting a single image.

6. The print support system according to claim 1, further comprising:
a print job definition data generation unit configured to generate print job definition data including printing specifications or printing settings on the basis of a result of the estimation obtained using the final print appearance estimation unit.

7. The print support system according to claim 6, further comprising:
a printing apparatus information obtaining unit configured to obtain printing apparatus information indicating a capability of a printing apparatus,
wherein the print job definition data generation unit generates, in accordance with the result of the estimation obtained using the final print appearance estimation unit, the print job definition data including information about the printing settings of the printing apparatus, printing apparatus information of which was obtained by the printing apparatus information obtaining unit.

8. A print support method for supporting a printing operation of printing content represented by content data having a plurality of pages so that a final print appearance suitable for the content data is attained, the print support method comprising:
obtaining the content data; and
estimating the final print appearance of the content data on the basis of content continuity of the obtained content data.

9. A print support system which supports a printing operation of printing content represented by content data so that a final print appearance suitable for the content data is attained, the print support system comprising:
a content data obtaining unit configured to obtain the content data;
a print job definition data obtaining unit configured to obtain print job definition data including information about a first final print appearance of the content represented by the content data;
a final print appearance estimation unit configured to estimate information about a second final print appearance of the content represented by the content data on the basis of the content data obtained using the content data obtaining unit; and
a print job definition data evaluation unit configured to determine whether the information about the first final print appearance included in the print job definition data obtained using the print job definition data obtaining unit matches the information about the second final print appearance estimated using the final print appearance estimation unit, and configured to output an alert through a user interface when mismatch between the information about the first final print appearance and the information about the second final print appearance is detected.

10. The print support system according to claim 9, further comprising:
a print job definition data generation unit configured to generate, when the print job definition data evaluation unit outputs the information about the first final print appearance and the information about the second final print appearance as candidates of a selection through the user interface and when the mismatch between the information about the first final print appearance and the information about the second final print appearance is detected, print job definition data including one from among the information about the first final print appearance and the information about the second final print appearance inputted as a result of the selection.

11. A print support method for supporting a printing operation of printing content represented by content data so that a final print appearance suitable for the content data is attained, the print support method comprising:
obtaining the content data;
obtaining print job definition data including information about a first final print appearance of the content data;
estimating information about a second final print appearance of the content data on the basis of the obtained content data; and
determining whether the information about the first final print appearance included in the print job definition data obtained using the print job definition data obtaining unit matches the information about the second final print appearance estimated using the final print appearance estimation unit, and outputting an alert through a user interface when mismatch between the information about the first final print appearance and the information about the second final print appearance is detected.
